(19) United States
(12) Patent Application Publication
(10) Pub. No.: US 2002/0174094 A1
(43) Pub. Date: Nov. 21, 2002

(54) Dataless applications

(76) Inventor: Serge Loffe, San Francisco, CA (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/910,103

(22) Filed: Jul. 19, 2001

Related U.S. Application Data
(60) Provisional application No. 60/292,839, filed on May 21, 2001.

(51) Int. Cl. G06F 9/46; G06F 9/00; G06F 17/30; G06F 7/00

(52) U.S. Cl. 707/1

(57) ABSTRACT

The disclosure is a system for providing additional application software to an existing data center without the need for additional databases being added. The additional application software is added by connecting the main database and any existing auxiliary databases of an initial application with an interface module. The additional application software is also connected with the interface module that translates data formats from the additional application software and the main and auxiliary databases of the initial application. Use of the interface module allows the additional application software to be added to the application already existing within a data center without additional databases being added.

In one embodiment, the interface module may reside at an ASP site. In another embodiment, the interface module may reside within the added application software. In another embodiment, the interface module may reside within the data center that houses the initial application.

The present application claims priority to the provisional filed application entitled Dataless Applications, filed on May 21, 2001, Ser. No. 60/292,839, which is also incorporated herein by reference.

### FIELD OF THE INVENTION

The present invention relates to the field of data processing systems.

### BACKGROUND

Typically, applications need data as both an input and an output in order to operate. For example, when an application processes data, it takes part of the data in, modifies it, and writes it back out. Additional data should often be maintained for internal processing purposes. Thus, when new applications are added to an existing system, one consequence may be that additional auxiliary databases are added as well so the main database does not have to be continually adapted to new applications.

FIG. 1 shows an example of such a case in which an additional database is added. In the computing system 105 of a data center 110, an application 100 is added. The application 100 uses the main database 101 and has also an additional database 102 for auxiliary data. The two databases 101 and 102 are connected to application 100 by logical connections 111 and 112, respectively. When a new application 100 is added, an additional auxiliary database 102 is also added, to avoid the possibility of modifying the main database 101.

Using modern Open Database Connectivity (ODBC) systems such as system 105, databases 101 and 102 may appear to the application as a single, enhanced database, but in reality, an additional database is still required for the application to function.

FIG. 2 shows a typical application 100 running in a data center 110, using a database system 105 with a second application 200 running at an application service provider (ASP) 210. The second application 200 may have its own auxiliary database 202a sitting inside the ODBC system 105 of the primary data center 110. In other cases the ASP may have a local database 202b, or a copy of the main database plus an auxiliary local database 202b.

The main application 200 has logical connections 211 and 212 to the main database 101 and the auxiliary database 202a, but in some cases it may appear that only one connection exists, because the ODBC system 105 can cause the two databases to appear as a single, new database.

What is needed is a method that allows applications to be “dataless,” in such a way that even though they work on existing databases, they do not require additional auxiliary databases to functionally operate.

### SUMMARY OF THE INVENTION

In one embodiment, a system for providing additional software to an existing data center without the need for additional databases being added is disclosed. The additional software is added by connecting a first application with a first database and a second database, connecting an interface module to the first database and the second database, connecting a second application to the interface module, and translating data formats from the second application and the first database and the second database within the interface module to allow data to be processed without a local database for the second application.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is an illustrative example of the Prior Art in which an application within a data center has multiple databases.

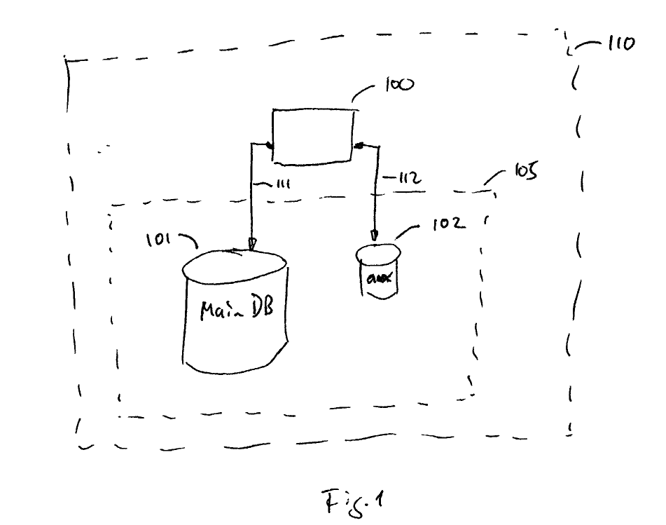

FIG. 2 is an illustrative example of the Prior Art in which a second application is connected to a main database and has its own local database and its own auxiliary database.

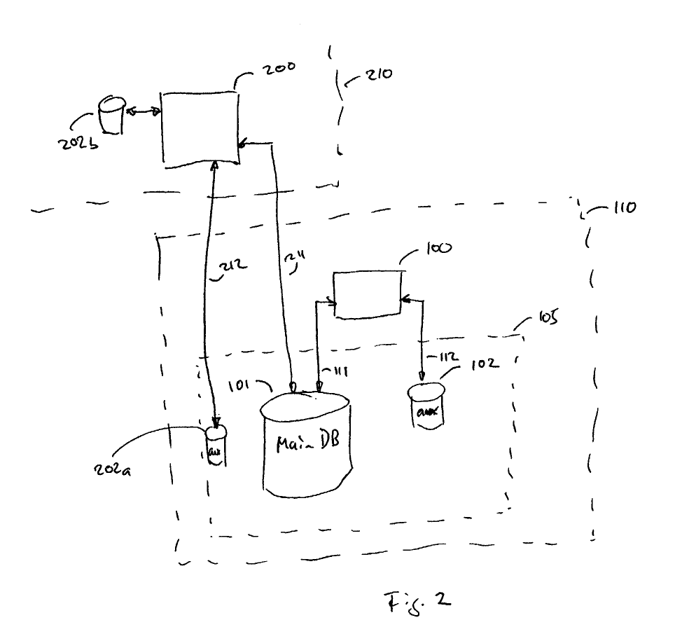

FIG. 3 is an overview illustration of a second application being connected with a main database and an auxiliary database of a first application through an interface module that allows the second application to be added without the need for its own local database or auxiliary database, according to one embodiment.

### DETAILED DESCRIPTION OF THE INVENTION

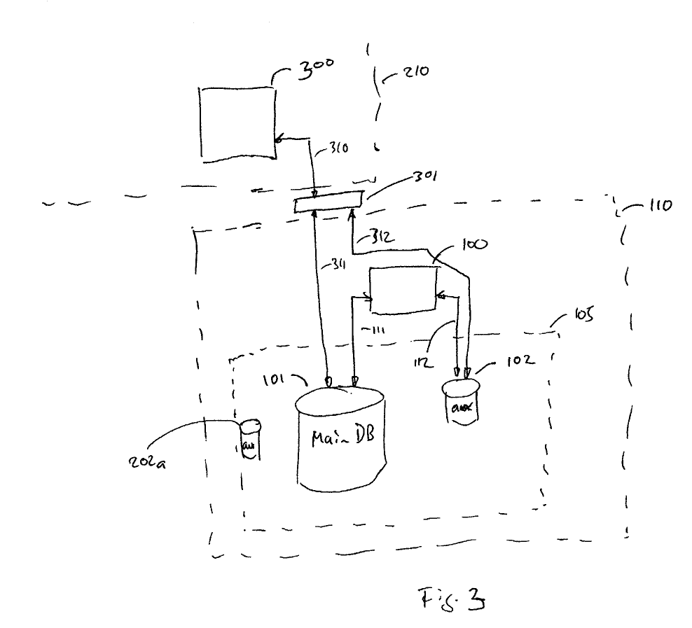

FIG. 3 illustrates a block diagram according to one embodiment. A first application 100 runs in a data center 110 and uses a computing system 105. The application 100 has access to a main database 101 and an auxiliary database 102 for additional data.

Application software 300 runs at an ASP site 210 that allows access to a network (such as the internet). The application software 300 needs access to the main database 101. In some cases, the application software 300 may also need to access the existing auxiliary database 102 of the first application 100. A single connection 310 exists to access data residing within the computing system 105 of the data center 110. The single connection 310 connects to the databases 101 and 102 through an interface module 301.

In one embodiment, the interface module 301 that provides interface functions for the application software 300 is connected to the main database 101 through a first logical connection 311 and to the auxiliary database 102 used for auxiliary data through a second logical connection 312. In one embodiment, the interface module 301 can translate the various data formats of the application software 300 and the two databases—the main database 101 and the auxiliary database 102. Therefore, due to the translation by the interface module, the application software 300 can exist without an added database (such as local database 202b) and, in one embodiment, is connected only to the existing databases 101 and 102. The application software 300 is then essentially running “dataless,” without any additional data having to be provided by a local database.

In one embodiment, the interface module 301 is software residing at the ASP site 210. It may be integrated into the application software 300 in the ASP site 210. In another embodiment, the interface module 301 may be software residing at the data center 110. In yet another embodiment, the interface module 301 may reside on a separate server (not shown).

There is no connection to an auxiliary database 202a. Therefore, neither the auxiliary database 202a for the application software 300 nor a local database 202b within the ASP site 210 need to exist.

A system as described here makes it easier for new application software 300 provided by an application service provider at an ASP site to be used simultaneously by multiple customers, such as data center 110. The ease of use occurs because additional specialized databases no longer need to be created for each instance of running application software 300. Additionally, since the application software 300 does not have its own data, new revisions do not require databases to be upgraded or migrated, which can be a very costly and cumbersome process.

The above embodiments can also be stored on a device or be read by a machine to perform instructions. The machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.). The device or machine-readable medium may include a solid state memory device and/or a rotating magnetic or optical disk. The device or machine-readable medium may be distributed when partitions of instructions have been separated into different machines, such as across an interconnection of computers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

Thus, a method and system for providing additional applications to an existing data center, without requiring the need for additional databases to be added with the additional application is disclosed.

### What is claimed is:

1. A method comprising the steps of:
connecting a first application with a first database and a second database;
connecting an interface module to the first database and the second database;
connecting a second application to the interface module; and
translating data formats from the second application and the first database and the second database within the interface module to allow data to be processed without a local database for the second application.

2. The method of claim 1, wherein the interface module resides at a local application service provider (ASP) site.

3. The method of claim 1, wherein the first application is run with the first database and the second database within a data center.

4. The method of claim 3, wherein the interface module resides in the data center.

5. The method of claim 1, wherein the interface module is integrated into the second application software.

6. The method of claim 1, wherein the interface module resides on a separate server.

7. A machine-readable storage medium tangibly embodying a sequence of instructions executable by the machine to perform a method, the method comprising the steps of:
connecting a first application with a first database and a second database;
connecting an interface module to the first database and the second database;
connecting the second application to the interface module; and
translating data formats from the second application and the first database and the second database within the interface module to allow data to be processed without a local database for the second application.

8. The machine-readable medium of claim 7, wherein the interface module resides at a local application service provider (ASP) site.

9. The machine-readable medium of claim 7, wherein the first application is run with the first database and the second database within a data center.

10. The machine-readable medium of claim 9, wherein the interface module resides in the data center.

11. The machine-readable medium of claim 7, wherein the interface module is integrated into the second application software.

12. The machine-readable medium of claim 7, wherein the interface module resides on a separate server.

13. A system comprising:
a first application being connected to a first database and a second database;
a second application; and
an interface being connected to the first database by a first connection, the second database by a second connection, and the second application by a third connection, the interface translating data formats from the first database, the second database, and the second application so that data from the second unit may be processed without a local database for the second unit.

14. The system of claim 13, wherein the first application is run in a data center.

15. The system of claim 13, wherein the first application is run with the first database and the second database within the data center.

16. The system of claim 13, wherein the second application resides at a local application service provider (ASP) site.

17. The system of claim 13, wherein the interface resides at a local application service provider (ASP) site.

18. The system of claim 14, wherein the interface resides in the data center.

19. The system of claim 13, wherein the interface is integrated into the second application software.

20. The system of claim 13, wherein the interface resides on a separate server.
